(19) United States
(12) Patent Application Publication
(10) Pub. No.: US 2017/0307931 A1
(43) Pub. Date: Oct. 26, 2017

(54) Black Matrix, Display Substrate, Display Screen and Display Device

(71) Applicants: BOE Technology Group Co., Ltd., Beijing (CN); Beijing BOE Optoelectronics Technology Co., Ltd., Beijing (CN)

(72) Inventors: Wenpeng Zhang, Beijing (CN); Xiuliang Wang, Beijing (CN); Zhinan Zhang, Beijing (CN); Yujia Wang, Beijing (CN)

(73) Assignees: BOE Technology Group Co., Ltd., Beijing (CN); Beijing BOE Optoelectronics Technology Co., Ltd., Beijing (CN)

(21) Appl. No.: 15/325,164

(22) PCT Filed: Jul. 8, 2016
(86) PCT No.: PCT/CN2016/089406

§ 371 Date: Jan. 10, 2017

(30) Foreign Application Priority Data
Oct. 27, 2015 (CN) 201510706520.9

(51) Int. Cl. G02F 1/1335; G02F 1/1339

(52) U.S. Cl. CPC G02F 1/133512; G02F 1/133514; G02F 1/13394

(57) ABSTRACT

A black matrix, a display substrate, a display screen and a display device are provided. The black matrix includes a plurality of openings of a mesh, and shielding regions configured to shield each main support column provided on the black matrix. When each main support column moves, a vertical projection of a movable area of the main support column on the black matrix falls within the shielding region corresponding to the main support column.

### TECHNICAL FIELD

Embodiments of the present disclosure relate to a black matrix, a display substrate, a display screen and a display device.

### BACKGROUND

With the continuous development of liquid crystal displays (LCDs), high-resolution products are continuously developed. However, with the increased amount of pixels, the distance from a support column to a pixel is also sustainedly reduced, and a series of problems may occur.

### SUMMARY

Embodiments of the present disclosure provide a black matrix, a display substrate, a display screen and a display device, which are used to improve the display effect of the display device.

An embodiment of the present disclosure provides a black matrix. The black matrix includes a plurality of transverse walls; a plurality of longitudinal walls intersected with the plurality of transverse walls, wherein the plurality of transverse walls and the longitudinal walls forms a mesh with a plurality of openings; and a shielding region configured to shield a main support column being selectively provided at an intersected position of the transverse walls and the longitudinal walls of the black matrix. The shielding region completely covers the selected intersected position. Total area of the shielding regions is greater than total area of the intersected positions of the transverse walls and the longitudinal walls without the shielding regions; and a movable area of the main support column is within the corresponding shielding region.

In an example, the shielding region has a center which is the same as a center of the selected intersected position.

In an example, the shielding region is in a shape of rectangle, circle or diamond.

In an example, the main support column has a cylindrical structure; and an axial line of the support column runs through a center point of a corresponding shielding region.

In an example, a difference between the vertical distance from a boundary line of the shielding region to the axial line of the support column and a radius of the main support column is more than or equal to 1 μm.

In an example, the difference between the distance from the boundary line of the shielding region to the axial line of the main support column and the radius of the support column is more than or equal to 1 μm.

In an example, a second shielding region configured to shield a secondary support column is selectively provided at an intersected position of the transverse walls and the longitudinal walls of the black matrix. The second shielding region completely covers the selected intersected position; and a movable area of the secondary support column is within the corresponding second shielding region.

Embodiments of the present disclosure also provides a display substrate. The display substrate includes a substrate, the black matrix provided on the substrate, and a pixel color filter (CF) layer provided in the openings of the black matrix.

An embodiment of the present disclosure also provides a display screen. The display screen includes two opposite substrates, and a liquid crystal layer provided between the two opposite substrates, a black matrix and a plurality of support columns. The black matrix includes transverse walls and longitudinal walls. The plurality of support columns includes main support columns and secondary support columns. Area of an end surface of the main support columns is larger than area of an end surface of the secondary support columns. The support columns are provided at intersected positions of the transverse walls and the longitudinal walls. Shielding regions are configured to shield main support columns at the intersected positions. Each shielding region completely covers the selected intersected position. A movable area of each of the main support column is within the shielding region.

An embodiment of the present disclosure also provides a display device. The display device includes a body and the display screen provided on the body.

### BRIEF DESCRIPTION OF THE DRAWINGS

Embodiments of the present disclosure will be described in detail hereinafter in conjunction with accompanying drawings to allow one of ordinary skill in the art to understand the present disclosure more clearly, in which:

FIG. 1 is a schematic structural view of a black matrix; and

FIG. 2 is a schematic structural view of a black matrix provided by an embodiment of the present disclosure.

### DETAILED DESCRIPTION

Technical solutions according to the embodiments of the present disclosure will be described clearly and completely as below in conjunction with the accompanying drawings of embodiments of the present disclosure. It is apparent that the described embodiments are only a part of but not all of exemplary embodiments of the present disclosure. Based on the described embodiments of the present disclosure, various other embodiments can be obtained by those of ordinary skill in the art without creative labor and those embodiments shall fall into the protection scope of the present disclosure.

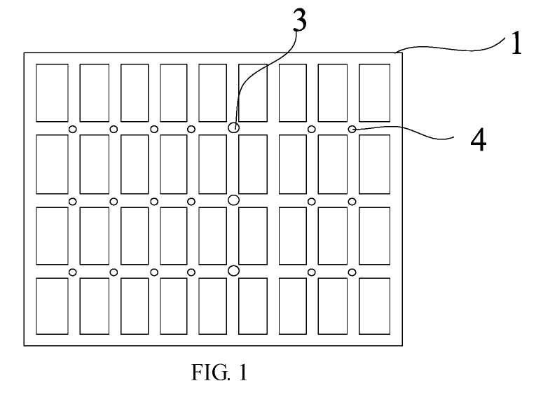

As illustrated in FIG. 1, a display includes a display area and a non-display area. A black matrix 1 is disposed in the non-display area. Support columns are arranged at selected positions of the black matrix. The support columns include a plurality of main support columns 3 and secondary support columns 4. When the display is pressed, the main support columns 3 will move in some certain displacement. The main reason of poor pressing effect of the display is in that, when a shear direction force is externally applied to a display panel, an instantaneous dislocation occurs between a color filter (CF) substrate and an array substrate in opposite directions, and an alignment film on the array substrate corresponding to the main support column 3 is damaged due to the action of the main support column, to allow the display panel to be brighter on the periphery of the main support column 3, and the display effect of the display screen can be affected.

To improve the display effect of the display device, embodiments of the present disclosure provide a black matrix, a display substrate, a display screen and a display device. In the technical proposals of the embodiments of the present disclosure, the light phenomenon which occurs when an alignment film is damaged due to the movement of support columns can be avoided by improving the area of shielding regions on the black matrix corresponding to main support columns. Detailed description will be given below with reference to the accompanying drawings and the embodiments for helping understanding of the technical proposals of the present disclosure.

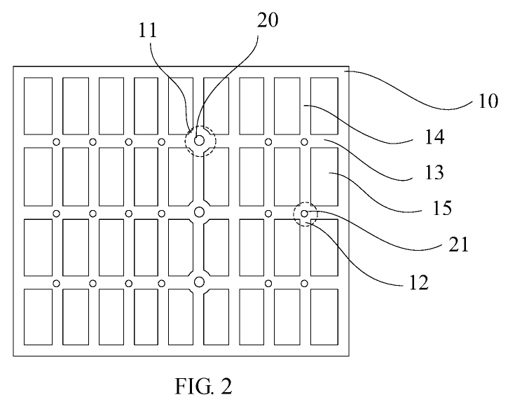

FIG. 2 is a schematic structural view of a black matrix provided by an embodiment of the present disclosure.

As illustrated in FIG. 2, a black matrix 10 is provided. The black matrix 10 includes a plurality of transverse walls 13 and a plurality of longitudinal walls 14 which are intersected with each other. A mesh-like structure is defined by the plurality of transverse walls 13 and the plurality of longitudinal walls 14 with a plurality of openings 15, and a shielding region for shielding each main support column 20 is selectively disposed at an intersected position of the transverse walls 13 and the longitudinal walls 14 of the black matrix. The shielding region completely covers the selected intersected position. The total area of the shielding regions is greater than the total area of intersected positions of the transverse walls 13 and the longitudinal walls 14 without the shielding regions. A movable area of the main support column 20 is within the shielding region.

In the embodiment, the area of the shielding region on the black matrix 10 corresponding to the main support column 20 is improved, so that the movable range of the main support column 20 can entirely fall within the shielding region corresponding to the main support column when the main support column 20 moves. When a light leakage phenomenon may occur due to the damage of an alignment film when the main support column 20 moves, the arranged shielding region can shield light, so that the light leakage phenomenon of the display screen can be avoided, and the display effect of the display can be improved.

Detailed description will be given below with reference to the accompanying drawings for helping understanding of the black matrix 10 provided by the embodiment of the present disclosure.

Continuing to refer to FIG. 2, FIG. 2 is a schematic structural view of the black matrix 10 provided by the embodiment of the present disclosure. As seen from FIG. 2, regions for shielding support columns are disposed on the black matrix 10 provided by the embodiment. The shielding regions are divided into first shielding regions 11 for shielding main support columns 20 and second shielding regions 12 for shielding secondary support columns 21. In the black matrix 10, the first shielding regions 11 make contact with the main support columns 20 correspondingly, and the second shielding regions 12 make contact with the secondary support columns 21 correspondingly. A vertical projection of a movable area of the support column on the black matrix 10 falls within the shielding region corresponding to the support column. That is to say, when the touch panel is pressed, no matter how the main support column 20 moves, the movable range entirely falls within the first shielding region 11. In this way, even the alignment film is damaged when the main support column 20 moves, the arranged first shielding region 11 will also shield the damaged area, so that light exposed from the damaged area cannot be emitted out. In this way, the light leakage phenomenon can be avoided, and the display effect of the display screen can be improved.

For instance, a center of the shielding region is the same as a center of the selected intersected position. That is to say, center points of the first shielding region 11 and the second shielding region 12 are respectively the same as center points of the intersected positions provided with the first shielding region and the second shielding region, so that it can avoid dimensions of different openings 15 near the intersected positions are different.

For instance, the shape of the first shielding region 11 may be different, e.g., it may be circular, rectangular, elliptical, diamond-shaped or irregular. In the embodiment, the first shielding region 11 is rectangular, circular or diamond-shaped.

In addition, the support columns in the embodiment may adopt different shapes, e.g., they may be cylindrical structures. Axial lines of the main support columns 20 run through center points of shielding regions corresponding to the main support columns. That is to say, the axial line of the main support column 20 is overlapped with the axial line of the first shielding region 11, so that the main support column 20 can be disposed at a central position of the first shielding region 11. By this design, the distance from the main support column 20 to any part of the boundary line of the first shielding region 11 is consistent, to allow the first shielding region 11 to shield the main support column when the main support column 20 moves in any direction. By this design, the first shielding region 11 may adopt small design area, to avoid the first shielding region 11 impacting the light transmittance of the display.

For instance, the difference between the vertical distance from the boundary line of the shielding region to the axial line of the support column and the radius of the support column is not less than about 1 μm. In this way, it allows the first shielding region 11 to completely cover the movable range of the main support column 20, and the impact of the first shielding region 11 to the light transmittance of the display can be maximally reduced.

For instance, the second shielding region 12 corresponding to the secondary support column 21 may also adopt similar design of the first shielding region 11. That is to say, when each secondary support column 21 moves, a vertical projection of a movable area of the secondary support column 21 on the black matrix 10 falls within the shielding region corresponding to the secondary support column, namely the second shielding region 12 completely covers the movable range of the secondary support column 21. In this way, the light leakage phenomenon which occurs when the alignment film is damaged due to the movement of the secondary support column 21 can be avoided.

An embodiment of the present disclosure provides a display substrate, which includes a substrate, the black matrix 10 disposed on the substrate, and a CF layer disposed in openings 15 of the black matrix 10.

In the embodiments, the area of the shielding region on the black matrix 10 corresponding to the main support column 20 is improved. When the main support column 20 moves, the movable range of the main support column can entirely fall within the shielding region corresponding to the main support column. When a light leakage phenomenon may occur due to the damage of an alignment film when the main support column 20 moves, the arranged shielding region can shield light. In this way, the light leakage phenomenon of the display can be avoided, and the display effect of the display screen can be improved.

The embodiment of the present disclosure also provides a display screen, which includes two opposite substrates, and a liquid crystal layer and a plurality of support columns disposed between the two opposite substrates. The plurality of support columns include main support columns 20 and secondary support columns 21. The area of an end surface of the main support column 20 is greater than the area of an end surface of the secondary support column 21.

In the embodiment, the area of the shielding region on the black matrix 10 corresponding to the main support column 20 is improved, so that the movable range of the main support column can entirely fall within the shielding region corresponding to the main support column when the main support column 20 moves. When a light leakage phenomenon may occur due to the damage of an alignment film when the main support column 20 moves, the provided shielding region can shield light, so that the light leakage phenomenon of the display can be avoided, and the display effect of the display screen can be improved.

An embodiment of the present disclosure also provides a display device, which includes a body and the foregoing display screen disposed on the body.

In the embodiments, the area of the shielding region on the black matrix 10 corresponding to the main support column 20 is improved, so that the movable range of the main support column 20 can entirely fall within the shielding region corresponding to the main support column when the main support column 20 moves. When a light leakage phenomenon may occur due to the damage of an alignment film when the main support column 20 moves, the provided shielding region can shield light, so that the light leakage phenomenon of the display can be avoided, and the display effect of the display can be improved.

The foregoing is only the preferred embodiments of the present disclosure and not intended to limit the scope of protection of the present disclosure. Any change or replacement that may be easily thought of by those skilled in the art within the technical scope disclosed by the embodiment of the present disclosure shall fall within the scope of protection of the present disclosure.

The present application claims the benefits of and priority to the Chinese patent application No. 201510706520.9 filed on Oct. 27, 2015 and entitled “Black Matrix, Display Substrate, Display Screen and Display Device,” which is incorporated herein by reference in its entirety.

1. A black matrix, comprising:
a plurality of transverse walls;
a plurality of longitudinal walls intersected with the plurality of transverse walls, wherein the plurality of transverse walls and the longitudinal walls forms a mesh-like structure with a plurality of openings; and
a first shielding region configured to shield a main support column being selectively provided at an intersected position of the transverse walls and the longitudinal walls of the black matrix, wherein the first shielding region completely covers the selected intersected position; total area of the first shielding regions is greater than total area of the intersected positions of the transverse walls and the longitudinal walls without the first shielding regions; and a movable area of the main support column is within the corresponding first shielding region.

2. The black matrix according to claim 1, wherein the first shielding region has a center which is the same as a center of the selected intersected position.

3. The black matrix according to claim 1, wherein the first shielding region is in a shape of rectangle, circle or diamond.

4. The black matrix according to claim 1, wherein the main support column has a cylindrical structure; and an axial line of the support column runs through a center point of the corresponding first shielding region.

5. The black matrix according to claim 4, wherein a difference between the vertical distance from a boundary line of the first shielding region to the axial line of the support column and a radius of the main support column is more than or equal to 1 μm.

6. The black matrix according to claim 5, wherein the first shielding region is in a shape of a circle; and the difference between the distance from the boundary line of the circle to the axial line of the main support column and the radius of the support column is more than or equal to 1 μm.

7. The black matrix according to claim 1, wherein a second shielding region configured to shield a secondary support column is selectively provided at an intersected position of the transverse walls and the longitudinal walls of the black matrix; the second shielding region completely covers the selected intersected position; and a movable area of the secondary support column is within the corresponding second shielding region.

8. A display substrate, comprising a substrate, the black matrix according to claim 1 provided on the substrate, and a pixel color filter (CF) layer provided in the openings of the black matrix.

9. A display screen, comprising two opposite substrates, and a liquid crystal layer provided between the two opposite substrates, a black matrix and a plurality of support columns, wherein the black matrix comprises:
transverse walls;
longitudinal walls;
wherein the plurality of support columns includes main support columns and secondary support columns, area of an end surface of the main support columns is larger than area of an end surface of the secondary support columns, the plurality of support columns are provided at intersected positions of the transverse walls and the longitudinal walls;
first shielding regions configured to shield each main support column at the intersected positions, wherein each first shielding region completely covers the selected intersected position, and a movable area of each of the main support column is within the first shielding region.

10. The display screen according to claim 9, wherein a second shielding region configured to shield a secondary support column is selectively provided at an intersected position of the transverse walls and the longitudinal walls of the black matrix; the second shielding region completely covers the selected intersected position; and a movable area of the secondary support column is within the corresponding second shielding region.

11. A display device, comprising a body and a display screen provided on the body, wherein the display screen comprises:
two opposite substrates, and a liquid crystal layer provided between the two opposite substrates, a black matrix and a plurality of support columns, wherein the black matrix comprises,
transverse walls;
longitudinal walls;
wherein the plurality of support columns includes main support columns and secondary support columns, area of an end surface of the main support columns is larger than area of an end surface of the secondary support columns, the plurality of support columns are provided at intersected positions of the transverse walls and the longitudinal walls;
first shielding regions configured to shield each main support column at the intersected positions, wherein each first shielding region completely covers the selected intersected position, and a movable area of each of the main support column is within the first shielding region.

12. The black matrix according to claim 2, wherein the first shielding region is in a shape of rectangle, circle or diamond.

13. The black matrix according to claim 2, wherein the main support column has a cylindrical structure; and an axial line of the support column runs through a center point of the corresponding first shielding region.

14. The black matrix according to claim 3, wherein the main support column has a cylindrical structure; and an axial line of the support column runs through a center point of the corresponding first shielding region.

15. The black matrix according to claim 12, wherein the main support column has a cylindrical structure; and an axial line of the support column runs through a center point of the corresponding first shielding region.

16. The black matrix according to claim 14, wherein a difference between the vertical distance from a boundary line of the first shielding region to the axial line of the support column and a radius of the main support column is more than or equal to 1 μm.

17. The black matrix according to claim 16, wherein the first shielding region is in a shape of a circle; and the difference between the distance from the boundary line of the circle to the axial line of the main support column and the radius of the support column is more than or equal to 1 μm.
